(19) United States
(12) Patent Application Publication
(10) Pub. No.: US 2004/0059500 A1
(43) Pub. Date: Mar. 25, 2004

(54) Navigation apparatus

(75) Inventor: Masahiko Nakano, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 10/619,034

(22) Filed: Jul. 15, 2003

(30) Foreign Application Priority Data
Jul. 18, 2002 (JP) 2002-209618

(51) Int. Cl. G01C 21/34

(52) U.S. Cl. 701/211; 701/209; 340/995.19

(57) ABSTRACT

A navigation apparatus displays information required reaching a destination on a display screen to guide a vehicle to the destination. The navigation apparatus includes first and second display control units. The first display control unit displays at least a part of a route to the destination on the display screen. The first display control unit also displays each of main points on the route as a mark on the display screen. The second display control unit determines whether or not a user selects one of the main points. The second display control unit also displays a real image showing surrounding of the selected main point on the display screen on the basis of position information of the selected main point and real image data corresponding to position coordinates, when the second display control unit determines that the user selects one of the main points.

The present disclosure relates to the subject matter contained in Japanese Patent Application No.2002-209618 filed on Jul. 18, 2002, which is incorporated herein by reference in its entirety.

### BACKGROUND OF THE INVENTION

1. Field of the Invention

This invention relates to a navigation apparatus and more particularly to a navigation apparatus using real image data corresponding to an image of a satellite photograph, an aerial photograph, etc., of the earth's surface.

2. Description of the Related Art

A navigation apparatus in a related art can display a map on a screen of a display based on map data recorded on a DVD-ROM, etc., and further can display the current position on the map and guide the user through the route to the destination based on the position data of the navigation apparatus.

However, since the navigation apparatus in the related art uses the map data to prepare the displayed map screen, it is difficult for the user to understand the current position through the map screen and grasp the actual circumstances surrounding the current position; this is a problem.

This problem is caused by the fact that the map screen is hard to represent the up and down positional relation of overpass and underpass roads, etc., and that, in fact, a large number of roads, buildings, etc., are not displayed on the map screen.

As one of means for solving such a problem, an art of displaying the current position on an aerial photograph screen prepared from aerial photograph data is disclosed in JP-A-5-113343. To use the aerial photograph screen, a building, etc., as a landmark becomes very easy to understand, thus making it possible for the user to easily understand the current position and also easily grasp the actual circumstances surrounding the current position.

However, if the aerial photograph screen is simply displayed as in the invention disclosed in gazette 1, a navigation apparatus to a sufficient level of user's satisfaction cannot be realized.

### SUMMARY OF THE INVENTION

It is therefore an object of the invention to provide a navigation apparatus for providing a high level of user's satisfaction by devising the display mode, etc., of a real image such as an aerial photograph screen.

To the end, according to the invention, according to a first aspect of the invention, a navigation apparatus displays information required reaching a destination on a display screen to guide a vehicle to the destination. The navigation apparatus includes a first display control unit and a second display control unit. The first display control unit displays at least a part of a route to the destination on the display screen and displays each of main points on the route as a mark on the display screen. The second display control unit determines whether or not a user selects one of the main points and displays a real image showing surrounding of the selected main point on the display screen on the basis of position information of the selected main point and real image data corresponding to position coordinates, when the second display control unit determines that the user selects one of the main points.

When displaying the route to the destination on the display screen, the navigation apparatus of the first aspect displays the main points on the route (for example, the destination, passed-through point before the destination is reached, starting point, interchange, etc.,) as marks. When the user selects any of the mark display points, the navigation apparatus displays the real image of the surroundings of the selected point (for example, satellite photograph, aerial photograph, etc.,) on the display screen.

Therefore, the real image covering a wide range and overlooked from a high place, such as a satellite photograph of the surroundings of each main point can be displayed, so that the user can previously keep track of the actual circumstances of the place (for example, peripheral facilities, road width, location conditions, availability of parking lot, etc.,) before arriving at the place such as the destination or passed-through point, for example.

The user-specified points (for example, user's home, acquaintance's home, user's place of employment, etc.,) may be included in the main points, so that it is made possible to display satellite photographs, etc., of not only the surroundings of the preset point, but also the surroundings of any specified point, and a very excellent navigation apparatus can be realized.

According to a second aspect of the invention, a navigation apparatus displays information required reaching a destination on a display screen to guide a vehicle to the destination. The navigation apparatus includes a third display control unit. The third display control unit determines whether or not a user gives a command to display a real image on the display screen, and displays a real image showing surrounding of a main point on a route to the destination on the display screen on the basis of real image data corresponding to the real image.

When the user enters a command to display a real image (for example, satellite photograph, aerial photograph, etc.,), the navigation apparatus of the second aspect displays the real image of the surroundings of the main point on the route to the destination (for example, starting point, passed-through point before the destination is reached, the destination, interchange, etc.,) on the display screen.

That is, the user simply enters a command to display a real image without finely specifying the point to display a real image of a satellite photograph, etc., whereby the real image of the surroundings of the main point on the route is displayed. It seems that there is a very high possibility that the user may want to keep track of the circumstances surrounding the main point on the route (for example, facilities, road width, location conditions, availability of parking lot, etc., in the surroundings of the passed-through point).

Therefore, the user performs simple operation of entering a command to display a real image, whereby the real image of the place of which the user wants to keep track is displayed, so that a navigation apparatus very excellent in operability can be realized. Particularly, it is difficult for the user to perform complicated operation during running and thus the navigation apparatus becomes very useful.

According to a third aspect of the invention, a navigation apparatus displays information required reaching a destination on a display screen to guide a vehicle to the destination. The navigation apparatus includes a first selection unit and a fourth display control unit. The first selection unit selects a point, a real image of which is to be displayed on the display screen, from among main points on a route to the destination on the basis of position information of the vehicle, position information of the main points, and positional relation between a position of the vehicle and that of each main position. The fourth display control unit displays on the display screen a real image showing surrounding of the point selected by the first selection unit on the basis of real image data corresponding to the real image.

The navigation apparatus of the third aspect selects a point to display a real image (for example, satellite photograph, aerial photograph, etc.,) from among the main points on the route (for example, the destination, passed-through point before the destination is reached, starting point, interchange, etc.,) from the positional relation between the current position and the main points, and displays the real image of the surroundings of the selected point on the display screen.

Therefore, the point concerning the current user position is automatically selected without the need for the user to select the point to display a real image of a satellite photograph, etc., and the real image of the surroundings of the selected point is displayed, so that the operability of the navigation apparatus is improved. Since the real image of the surroundings of the point concerning the current user position, of the main points on the route is displayed, information matching the user's desire can be provided for the user.

According to a fourth aspect, in the third aspect, the first selection unit selects a point at which the vehicle next arrives from among the main points as the point, a real image of which is to be displayed on the display screen, on the basis of the positional relation.

The navigation apparatus of the fourth aspect selects the point at which the user is scheduled to next arrive as the point to display a real image from among the main points on the route, so that the user can previously keep track of the actual circumstances of the place (for example, peripheral facilities, road width, location conditions, availability of parking lot, etc.,) before arriving at the place such as the destination or passed-through point, for example.

According to a fifth aspect of the invention, in the third aspect, the first selection unit selects a point which is closest to the vehicle from among the main points as the point, a real image of which is to be displayed on the display screen, on the basis of the positional relation.

The navigation apparatus of the fifth aspect selects the point nearest to the user (the point at which the user is scheduled to next arrive or the immediately preceding passed-through point) from among the main points on the route as the point to display the real image, so that the user can previously keep track of the actual circumstances of the point at which the user will soon arrive (for example, the destination, passed-through point, etc.,) before arriving at the place or can enjoy seeing what circumstances the point passed through a little before (for example, passed-through point, etc.,) was in, for example.

According to a sixth aspect of the invention, a navigation apparatus displays information required reaching a destination on a display screen to guide a vehicle to the destination. The navigation apparatus includes a second selection unit and a fifth display control unit. The second selection unit selects a point, a real image of which is to be displayed on the display screen, from among main points on a route to the destination on the basis of movement state of the vehicle. The fifth display control unit displays a real image showing surrounding of the point selected by the second selection unit on the basis of real image data corresponding to the real image.

The navigation apparatus of the sixth aspect selects a point to display a real image (for example, satellite photograph, aerial photograph, etc.,) from among the main points on the route (for example, the destination, passed-through point before the destination is reached, starting point, interchange, etc.,) based on the move situation of the user, and displays the real image of the surroundings of the selected point on the display screen.

Therefore, the point concerning the current user position is automatically selected without the need for the user to select the point to display a real image of a satellite photograph, etc., and the real image of the surroundings of the selected point is displayed, so that the operability of the navigation apparatus is improved. The real image of the surroundings of the point selected based on the move situation of the user, of the main points on the route is displayed. For example, the real image of the surroundings of the point at which the user is scheduled to next arrive is displayed, so that information matching the user's desire can be provided for the user.

### BRIEF DESCRIPTION OF THE DRAWINGS

FIG. 1 is a block diagram to schematically show the main part of a navigation apparatus according to a first embodiment of the invention.

FIG. 2 is a flowchart to show processing operation performed by a microcomputer in the navigation apparatus according to the first embodiment of the invention.

FIG. 3 is a drawing to show an example of a screen displayed on a display panel of the navigation apparatus according to the first embodiment of the invention.

FIG. 4 is a drawing to show an example of a screen displayed on the display panel of the navigation apparatus according to the first embodiment of the invention.

FIG. 5 is a drawing to show an example of a screen displayed on the display panel of the navigation apparatus according to the first embodiment of the invention.

FIG. 6 is a flowchart to show processing operation performed by a microcomputer in a navigation apparatus according to a second embodiment of the invention.

FIG. 7 is a drawing to show an example of a screen displayed on a display panel of the navigation apparatus according to the second embodiment of the invention.

FIG. 8 is a drawing to show an example of a screen displayed on the display panel of the navigation apparatus according to the second embodiment of the invention.

FIG. 9 is a drawing to show an example of a screen displayed on the display panel of the navigation apparatus according to the second embodiment of the invention.

FIG. 10 is a table indicating a part of route information to a destination.

FIG. 11 is a flowchart to show processing operation performed by a microcomputer in a navigation apparatus according to a third embodiment of the invention.

FIG. 12 is a flowchart to show processing operation performed by the microcomputer in the navigation apparatus according to the third embodiment of the invention.

### DETAILED DESCRIPTION OF THE PREFERRED EMBODIMENTS

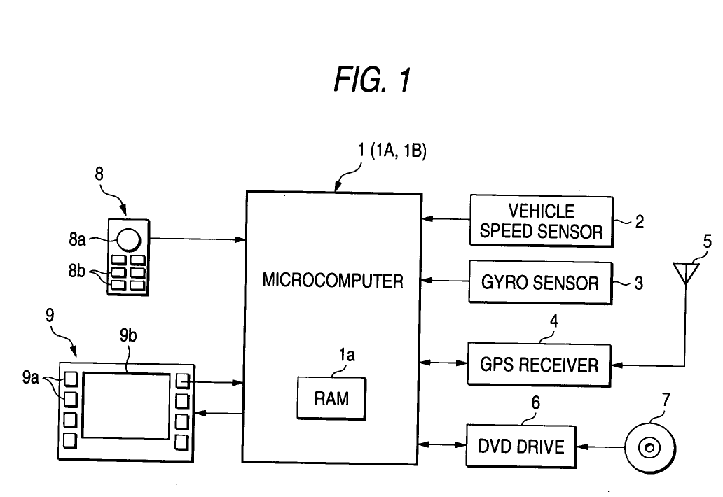

Referring now to the accompanying drawings, there are shown preferred embodiments of navigation apparatuss according to invention. FIG. 1 is a block diagram to schematically show the main part of a navigation apparatus according to a first embodiment.

A vehicle speed sensor 2 for computing from the vehicle speed and acquiring information concerning the traveled distance (mileage) and a gyro sensor 3 for acquiring information concerning the traveling direction are connected to a microcomputer 1. The microcomputer 1 can estimate the position of the vehicle installing the navigation apparatus (image display apparatus) based on the computed traveled distance information and traveling direction information (self-contained navigation).

A GPS receiver 4 receives a GSP signal from a satellite through an antenna 5 and is connected to the microcomputer 1. The microcomputer 1 can estimate the position of the vehicle installing the navigation apparatus based on the GPS signal (GPS navigation).

A DVD drive 6 capable of inputting map data, real image data, etc., from a DVD-ROM 7 (any other storage unit is also possible) recording map data and real image data of a wide-area bird's eye view of a satellite photograph of the earth's surface (data corresponding to a real image covering a wide range and overlooked from a high place) is also connected to the microcomputer 1, and the microcomputer 1 stores necessary map data and real image data from the DVD-ROM 7 in RAM 1a of the microcomputer 1 based on the estimated current vehicle position information, guide route information described later, and the like. To relate the real image data to position coordinates, a method of using latitudes and longitudes of the upper left corner and the lower right corner of a rectangular area represented by the real image data can be named.

The microcomputer 1 can match the estimated current vehicle position and the map data (can perform map matching processing), thereby displaying a map screen precisely indicating the current vehicle position on a display panel 9b. Switch signals output from a joystick 8a and button switches 8b placed on a remote control 8 and switch signals output from button switches 9a placed on a display 9 are input to the microcomputer 1, which then performs processing responsive to the switch signals. For example, when the microcomputer 1 reads information concerning a destination, a passed-through point via which the vehicle will go to the destination, etc., the microcomputer 1 finds an optimum route from the current vehicle position (starting point) to the destination (via the passed-through point) and displays the optimum route as a guide route on the display panel 9b together with the map screen.

A plurality of infrared LEDs and a plurality of phototransistors are placed facing each other at the top and bottom and left and right of the display panel 9b and can detect the position at which the user touches the display panel 9b, and the microcomputer 1 can acquire the detection result.

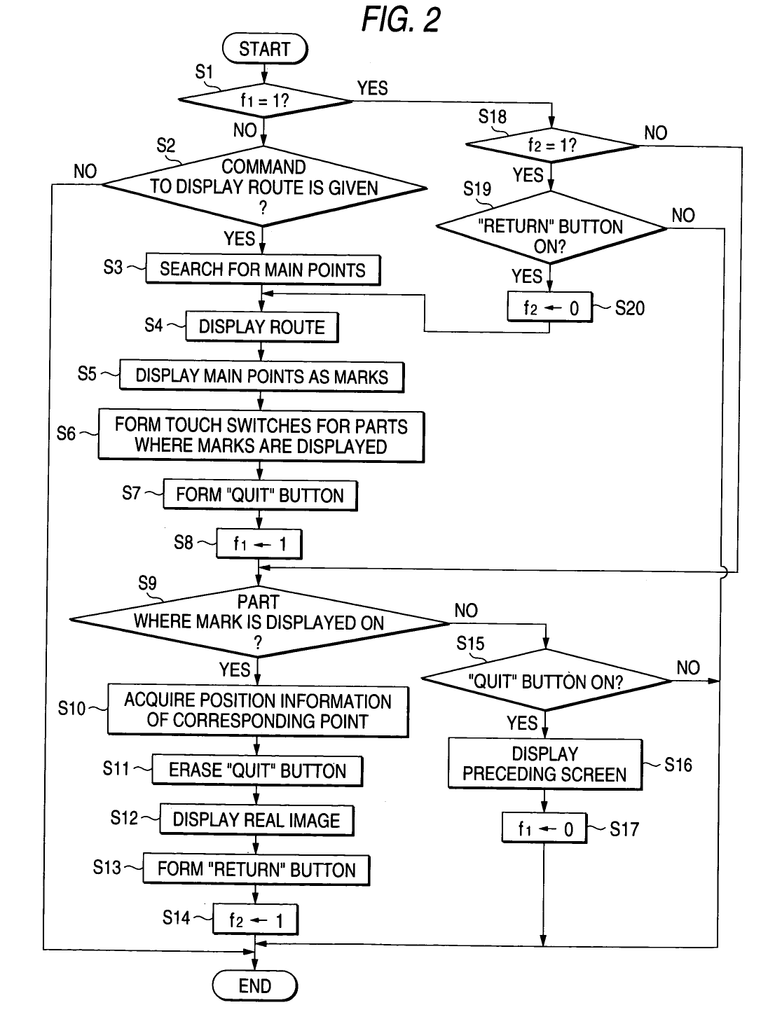

Next, a processing operation (1) performed by the microcomputer 1 in the navigation apparatus according to the first embodiment will be discussed based on a flowchart of FIG. 2. First, it is determined whether or not a flag f₁ is 1 (step S1). The flag f₁ indicates that the navigation apparatus is in a mode in which an overview of a route (guide route obtained on the basis of the destination and passed-through point previously entered by the user) or a real image of a main point is displayed on the display panel 9b (or a lower-order mode than that mode).

If it is concluded that the flag f₁ is not 1 (namely, the navigation apparatus is not in the mode in which an overview of the route is displayed), then it is determined whether or not the user operates the button switch 8a of the remote control 8 to give a command to display a route overview (step S2).

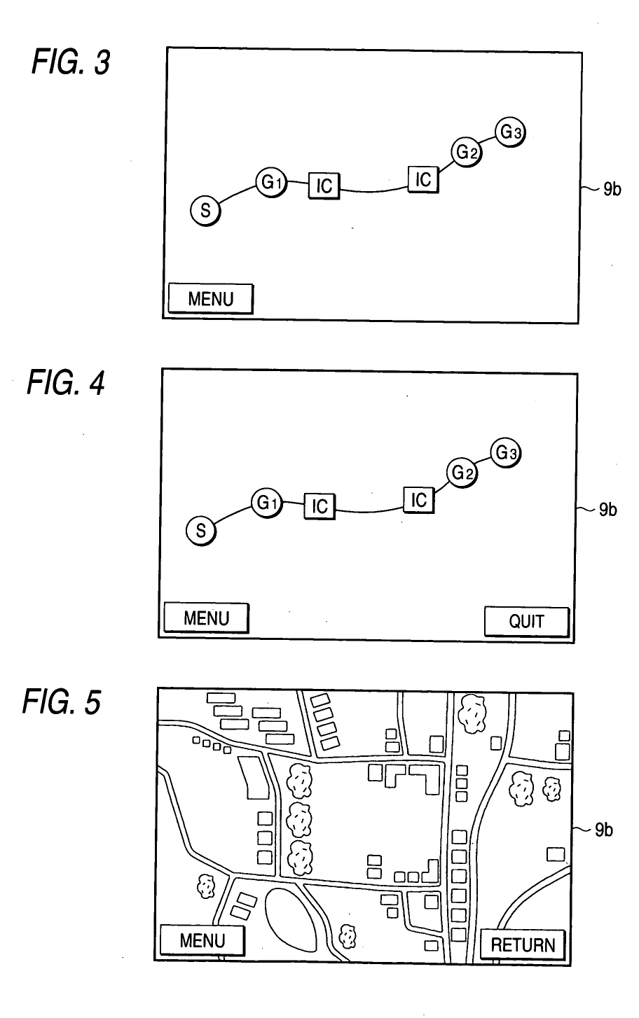

If it is concluded that the user gives the command to display the route overview, a search is made for main points on the route to the destination is reached (in this case, starting point, destination, passed-through point, and interchange) based on the guide route information (step S3). Next, the route is displayed on the display panel 9b based on the guide route information (step S4). The main points on the route are displayed as marks for each type based on the search result (step S5). On the other hand, if it is concluded that the user does not give the command to display the route overview, the processing operation (1) is terminated. FIG. 3 is a drawing to show a state in which the route overview is displayed on the display panel 9b.

Here, starting point, destination, passed-through point, and interchange are named as the main points, but the main points are not limited to them. In a navigation apparatus according to another embodiment, user-specified points (for example, user's home, acquaintance's home, user's place of employment, etc.,) may be included in the main points.

Next, touch switches are formed in a one-to-one correspondence with parts where the marks are displayed (step S6). A QUIT button switch (touch switch) is formed for the user to give a command to terminate display of the route overview (step S7). The flag f₁ indicating that the navigation apparatus is in the mode in which the route overview is displayed is set to 1 (step S8). Then, control goes to step S9. FIG. 4 is a drawing to show a state in which the QUIT button switch is formed on the display panel 9b.

At step S9, it is determined whether or not the user touches any touch switch formed in the parts where the marks are displayed display. If it is concluded that the user touches any touch switch, position information of the main point corresponding to the touched touch switch is read based on the guide route information (step S10).

Next, the QUIT button switch is erased (step S11). Then, based on the position information of the point read at step S10, a real image indicating the surroundings of the point is generated by a process, for example, including extracting the real image data from the real image data stored in the RAM 1a, and is displayed on the display panel 9b (step S12). A RETURN button switch (touch switch) is formed (step S13). Then, a flag f₂ indicating that the real image is displayed is set to 1 (step S14). FIG. 5 is a drawing to show a state in which the real image is displayed on the display panel 9b.

If it is concluded at step S9 that the user does not touch any touch switch formed in the parts where the marks are displayed, then it is determined whether or not the user touches the QUIT button switch (step S15). If it is concluded that the user touches the QUIT button switch, the screen preceding the route overview display screen (for example, menu screen) is displayed (step S16). Then, the flag f₁ is set to 0 (step S17). On the other hand, if it is concluded that the user does not touch the QUIT button switch, the processing operation (1) is terminated.

If it is concluded at step S1 that the flag f₁ is 1 (namely, the navigation apparatus is in the route overview display mode or a lower-order mode than the route overview mode), then it is determined whether or not the flag f₂ indicating that the real image is displayed is 1 (step S18). If it is concluded that the flag f₂ is not 1 (namely, the real image is not displayed), control goes to step S9.

On the other hand, if it is concluded that the flag f₂ is 1 (namely, the real image is displayed), then it is determined whether or not the user touches the RETURN button switch (step S19). If it is concluded that the user touches the RETURN button switch, it is assumed that the user makes a request for returning to the route overview display screen, the flag f₂ is set to 0 (step S20), and control goes to step S4. On the other hand, if it is concluded that the user does not touch the RETURN button switch, the processing operation (1) is terminated.

When the route to the destination on the display panel 9b is displayed, the navigation apparatus according to the first embodiment displays the main points on the route (for example, destination, passed-through point, starting point, interchange, etc.,) as marks. When the user selects any of the mark display points, the navigation apparatus displays the real image (for example, satellite photograph, aerial photograph, etc.,) of the surroundings of the selected point on the display panel 9b.

Therefore, the real image such as a satellite photograph of the surroundings of each main point can be displayed, so that the user can previously keep track of the actual circumstances of the place (for example, peripheral facilities, road width, location conditions, availability of parking lot, etc.,) before arriving at the place such as the destination or passed-through point, for example.

Next, a navigation apparatus according to a second embodiment of the invention will be discussed. The navigation apparatus according to the second embodiment has the same configuration as the navigation apparatus previously described with reference to FIG. 1 except for microcomputer 1. Therefore, the microcomputer is denoted by a different reference numeral 1A and other components will not be discussed again.

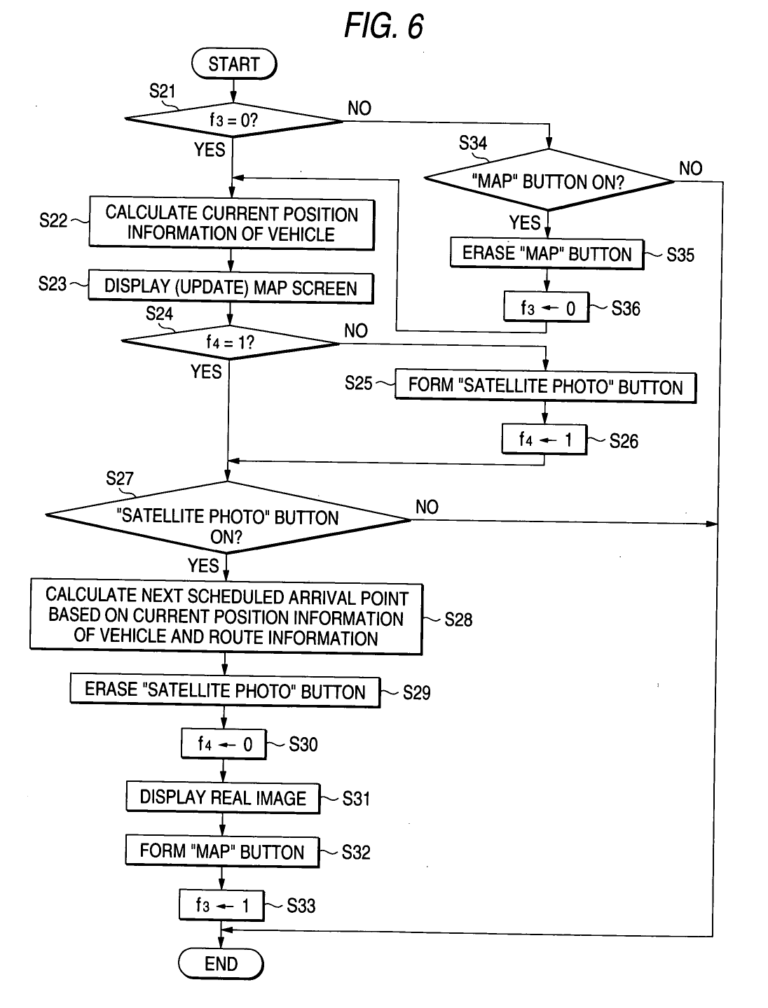

A processing operation (2) performed by the microcomputer 1A in the navigation apparatus according to the second embodiment will be discussed based on a flowchart of FIG. 6. First, whether or not it is determined a flag f₃ is 0 (step S21). The flag f₃ indicates a mode of a screen displayed on a display panel 9b

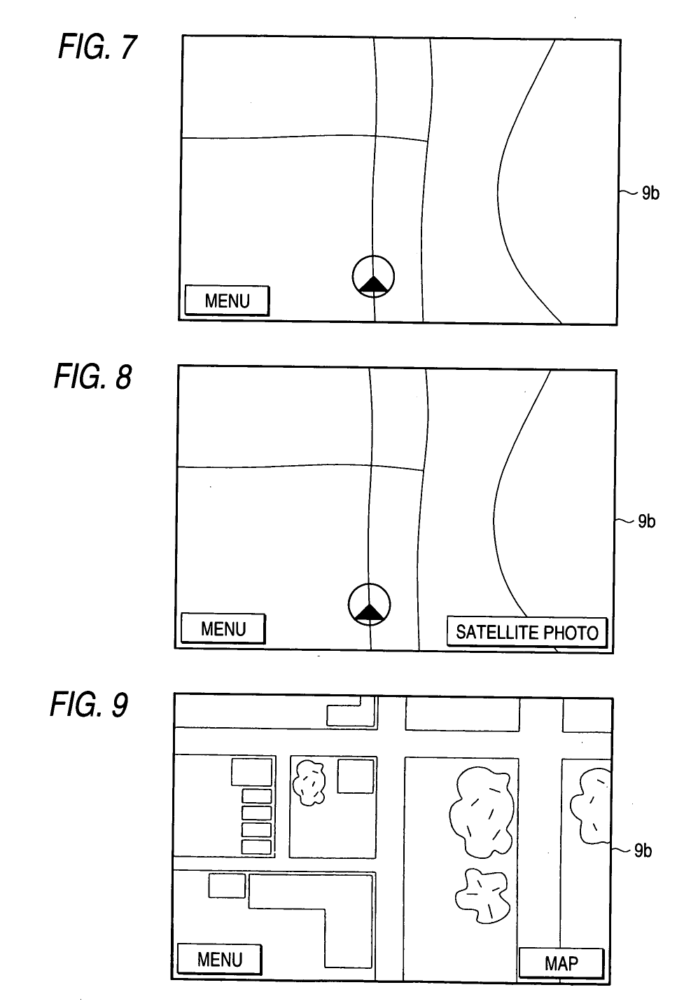

If it is concluded that the flag f₃ is 0 (namely, a normal map screen is displayed), then the current vehicle position is calculated from a GPS signal (step S22). Based on the calculated current vehicle position information, a map screen indicating the surroundings of the current vehicle position is generated by a process including, for example, extracting map data from map data stored in RAM 1a and is displayed on the display panel 9b (step S23). FIG. 7 is a drawing to show a state in which the map screen is displayed on the display panel 9b.

Next, it is determined whether or not a flag f₄ is 1 (step S24). The flag f4 indicates that a SATELLITE PHOTO button switch (touch switch) is formed. If it is concluded that the flag f₄ is not 1 (namely, the SATELLITE PHOTO button switch is not formed), the SATELLITE PHOTO button switch is formed (step S25). The flag f₄ is set to 1 (step S26) and then control goes to step S27.

On the other hand, if it is concluded that the flag f₄ is 1 (namely, the SATELLITE PHOTO button switch is formed), another SATELLITE PHOTO button switch need not be formed and thus control goes to step S27. FIG. 8 is a drawing to show a state in which the SATELLITE PHOTO button switch is formed on the display panel 9b.

At step S27, it is determined whether or not the user touches the SATELLITE PHOTO button switch. If it is concluded that the user touches the SATELLITE PHOTO button switch, a point at which the vehicle is scheduled to next arrive, is obtained from among the main points on the route to the destination (in this case, destination, passed-through point, and interchange) on the basis of the current vehicle position information and guide route information (step S28). On the other hand, if it is concluded that the user does not touch the SATELLITE PHOTO button switch, the processing operation (2) is terminated.

Next, the SATELLITE PHOTO button switch is erased (step S29) and the flag f₄ is set to 0 (step S30). Then, a real image showing the surroundings of the point is displayed on the display panel 9b on the basis of position information of the point obtained at step S28 and real image data stored in the RAM 1a (step S31). A MAP button switch is formed (step S32) Then, the flag f₃ is set to 1 (step S33) FIG. 9 is a drawing to show a state in which the real image is displayed on the display panel 9b.

If it is concluded at step S21 that the flag f₃ indicating the mode of the screen displayed on the display panel 9b is not 0 (namely, the flag f₃ is 1, indicating that the real image of the surroundings of the main point is displayed), it is determined whether or not the user touches the MAP button switch (step S34).

If it is concluded that the user touches the MAP button switch, it is assumed that the user makes a request for displaying the normal map screen, the MAP button switch is erased (step S35) and the flag f₃ is set to 0 (step S36) and then control goes to step S22. On the other hand, if it is concluded that the user does not touch the MAP button switch, the processing operation (2) is terminated.

When the user enters a command to display a real image (for example, satellite photograph, aerial photograph, etc.,), the navigation apparatus according to the second embodiment displays the real image of the surroundings of the main point on the route to the destination (for example, passed-through point, destination, interchange, etc.,) on the display screen.

That is, when the user simply enters the command to display a real image without finely specifying the point to display a real image of a satellite photograph, etc., the real image of the surroundings of the main point on the route is displayed. It seems that there is a very high possibility that the user may want to keep track of the circumstances surrounding the main point on the route (for example, facilities, road width, location conditions, availability of parking lot, etc., in the surroundings of the passed-through point).

Accordingly, when the user performs a simple operation of entering the command to display a real image, the real image of the place of which the user wants to keep track is displayed. Therefore, a navigation apparatus very excellent in operability can be realized. Particularly, it is difficult for the user to perform complicated operation during driving and thus the navigation apparatus becomes very useful.

Further, the point at which the vehicle is scheduled to next arrive is selected as a point a real image of which is to be displayed from among the main points on the route, so that the user can previously keep track of the actual circumstances of the place before arriving at the place such as the destination or passed-through point, for example.

The navigation apparatus according to the second embodiment obtains the point at which the vehicle is scheduled to next arrive based on the current vehicle position information and the route information, and displays the real image of the surroundings of the point at which the vehicle is scheduled to next arrive. However, a navigation apparatus according to a still another embodiment may obtain the point nearest to the vehicle from among the main points and may display the real image of the surroundings of the point nearest to the vehicle.

Next, a navigation apparatus according to a third embodiment of the invention will be discussed. The navigation apparatus according to the third embodiment has the same configuration as the navigation apparatus previously described with reference to FIG. 1 except for microcomputer land therefore the microcomputer is denoted by a different reference numeral 1B and other components will not be discussed again.

If the microcomputer 1B acquires information of a destination, a passed-through point, etc., as the user operates a button switch 8a of a remote control 8, etc., the microcomputer 1B can obtain an optimum route from the current vehicle position (starting point) via the passed-through point to the destination.

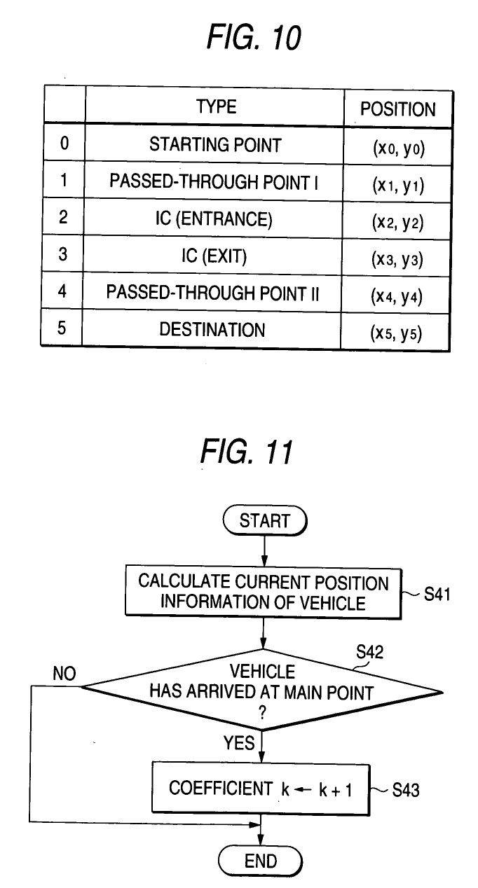

FIG. 10 is a table listing main points on the route until the destination is reached (here, starting point, passed-through point, interchange, and destination) in order; the digits 0 to 5 listed in the table indicate the order that the vehicle passes through the points. Position information of the main points and information concerning the order are stored in memory (not shown) in the microcomputer 1B as route information.

A processing operation (3) performed by the microcomputer 1B in the navigation apparatus according to the third embodiment will be discussed based on a flowchart of FIG. 11. First, the current vehicle position is calculated from a GPS signal, etc., (step S41). It is determined whether or not the vehicle has newly arrived at any of the main points on the basis of the calculated current vehicle position information and the route information (step S42).

If it is concluded that the vehicle has newly arrived at any of the main points, a coefficient k is incremented by one (the coefficient k is set to 0 at the initialization time, for example, the route setting time) (step S43). On the other hand, if it is concluded that the vehicle has not newly arrived at any of the main points, the processing operation (3) is terminated. That is, if the coefficient k is two, it means that the vehicle has arrived at the second point.

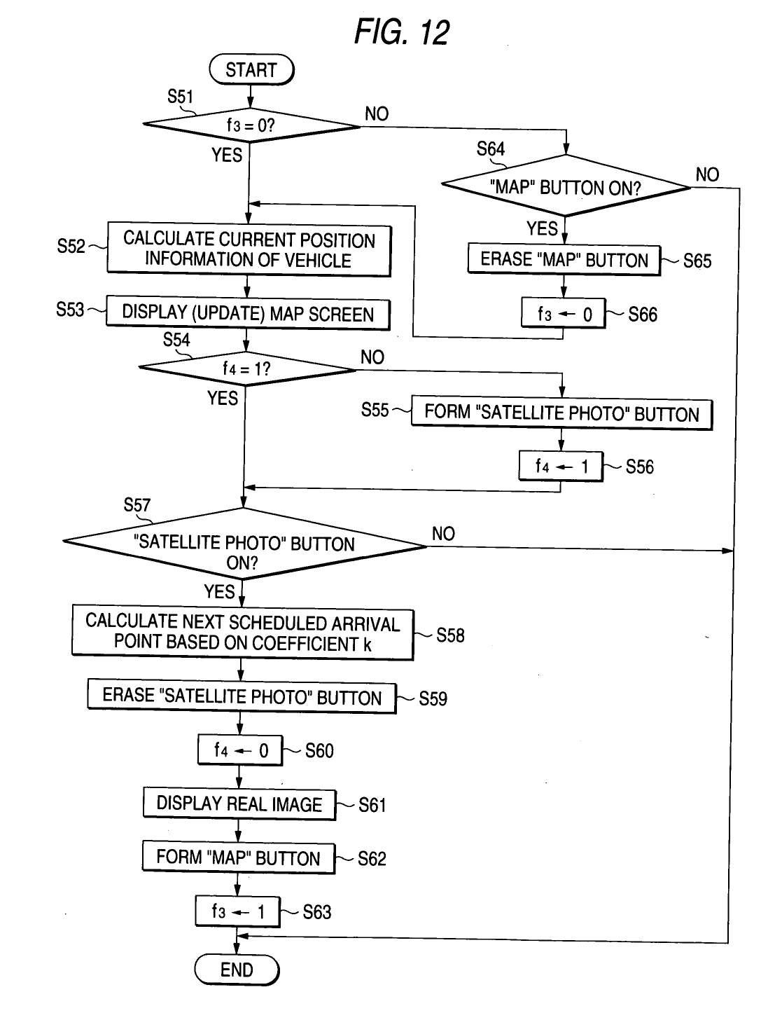

Next, a processing operation (4) performed by the microcomputer 1B in the navigation apparatus according to the third embodiment will be discussed based on a flowchart of FIG. 12. First, it is determined whether or not the flag f₃ indicating the mode of a screen displayed on a display panel 9b is 0 (step S51).

If it is concluded that the flag f₃ is 0 (namely, the normal map screen is displayed), then the current vehicle position is calculated from a GPS signal, etc., (step S52). Based on the calculated current vehicle position information, a map screen indicating the surroundings of the current vehicle position is generated by a process including, for example, extracting map data from map data stored in RAM 1a and is displayed on the display panel 9b (step S53). FIG. 7 shows a state in which the map screen is displayed on the display panel 9b.

Next, it is determined whether or not the flag f₄ indicating that the SATELLITE PHOTO button switch (touch switch) is formed is 1 (step S54). If it is concluded that the flag f₄ is not 1 (namely, SATELLITE PHOTO button switch is not formed), a SATELLITE PHOTO button switch is formed (step S55) and the flag f₄ is set to 1 (step S56). Then, control goes to step S57.

On the other hand, if it is concluded that the flag f₄ is 1 (namely, a SATELLITE PHOTO button switch is formed), another SATELLITE PHOTO button switch need not be formed. Thus, control goes to step S57. FIG. 8 shows a state in which the SATELLITE PHOTO button switch is formed on the display panel 9b.

At step S57, it is determined whether or not the user touches the SATELLITE PHOTO button switch. If it is concluded that the user touches the SATELLITE PHOTO button switch, the point at which the vehicle is scheduled to next arrive is obtained from among the main points on the route to the destination on the basis of the coefficient k (see step S43 in FIG. 11) (step S58). For example, if the coefficient k is three, it indicates that the vehicle passed through IC (exit) and is going to passed-through point II as shown in FIG. 10. Thus, the point at which the vehicle is scheduled to next arrive is the passed-through point II.

On the other hand, if it is concluded that the user does not touch the SATELLITE PHOTO button switch, the processing operation (4) is terminated.

Next, the SATELLITE PHOTO button switch is erased. (step S59) and the flag f₄ is set to 0 (step S60). Then, a real image indicating the surroundings of the point is displayed on the display panel 9b based on position information of the point obtained at step S58 and real image data stored in the RAM 1a (step S61). A MAP button switch is formed (step S62) and then the flag f₃ is set to 1 (step S63). FIG. 9 shows a state in which the real image is displayed on the display panel 9b.

If it is concluded at step S51 that the flag f₃ indicating the mode of the screen displayed on the display panel 9b is not 0 (namely, the flag f₃ is 1, indicating that the real image of the surroundings of the main point is displayed), it is determined whether or not the user touches the MAP button switch (step S64).

If it is concluded that the user touches the MAP button switch, it is assumed that the user makes a request for displaying the normal map screen, the MAP button switch is erased (step S65). The flag f₃ is set to 0 (step S66) and then control goes to step S52. On the other hand, if it is concluded that the user does not touch the MAP button switch, the processing operation (4) is terminated.

When the user enters a command to display a real image (for example, satellite photograph, aerial photograph, etc.,), the navigation apparatus according to the third embodiment displays the real image of the surroundings of the main point on the route to the destination (for example, destination, passed-through point, destination, interchange, etc.,) on the display screen.

That is, the user simply enters a command to display a real image without finely specifying the point to display a real image of a satellite photograph, etc., whereby the real image of the surroundings of the main point on the route is displayed. It seems that there is a very high possibility that the user may want to keep track of the circumstances surrounding the main point on the route (for example, facilities, road width, location conditions, availability of parking lot, etc., in the surroundings of the passed-through point).

Therefore, the user performs simple operation of entering a command to display a real image, whereby the real image of the place of which the user wants to keep track is displayed, so that a navigation apparatus very excellent in operability can be realized. Particularly, it is difficult for the user to perform complicated operation during running and thus the navigation apparatus becomes very useful.

Further, the point at which the vehicle is scheduled to next arrive is selected as the point to display a real image from among the main points on the route, so that the user can previously keep track of the actual circumstances of the place before arriving at the place such as the destination or passed-through point, for example.

To display the real image on the display panel 9b, the navigation apparatus according to the second or third embodiment displays the real image on the full screen of the display panel 9b. However, a navigation apparatus according to a different embodiment may display the map screen in the left half and the real image in the remaining right half.

Furthermore, in the navigation apparatus according to the second or third embodiment, when the real image is displayed on the display panel 9b, the real image of the surroundings of the point at which the vehicle is scheduled to next arrive is displayed. However, a navigation apparatus according to another embodiment may display all the real images of the main points in order of passing, may display all the real images of the main points in order of close to the current vehicle position, or may display all the real images of the main points in order of passing in a range of from the current vehicle position to the destination.

What is claimed is:

1. A navigation apparatus for displaying information required reaching a destination on a display screen to guide a vehicle to the destination, the navigation apparatus comprising:
a first display control unit for displaying at least a part of a route to the destination on the display screen and displaying each of main points on the route as a mark on the display screen; and
a second display control unit for determining whether or not a user selects one of the main points and displaying a real image showing surrounding of the selected main point on the display screen on the basis of position information of the selected main point and real image data corresponding to position coordinates, when the second display control unit determines that the user selects one of the main points.

2. A navigation apparatus for displaying information required reaching a destination on a display screen to guide a vehicle to the destination, the navigation apparatus comprising:
a third display control unit for determining whether or not a user gives a command to display a real image on the display screen, and displaying a real image showing surrounding of a main point on a route to the destination on the display screen on the basis of real image data corresponding to the real image.

3. A navigation apparatus for displaying information required reaching a destination on a display screen to guide a vehicle to the destination, the navigation apparatus comprising:
a first selection unit for selecting a point, a real image of which is to be displayed on the display screen, from among main points on a route to the destination on the basis of movement state of the vehicle; and
a fourth display control unit for displaying a real image showing surrounding of the point selected by the second selection unit on the basis of real image data corresponding to the real image.

4. The navigation apparatus according to claim 3, wherein: the movement state of the vehicle is position information of the vehicle, position information of the main points, and positional relation between a position of the vehicle and that of each main point.

5. The navigation apparatus according to claim 4, wherein the first selection unit selects a point at which the vehicle next arrives from among the main points as the point, a real image of which is to be displayed on the display screen, on the basis of the positional relation.

6. The navigation apparatus according to claim 4, wherein the first selection unit selects a point which is closest to the vehicle from among the main points as the point, a real image of which is to be displayed on the display screen, on the basis of the positional relation.
